(19) United States
(12) Patent Application Publication
(10) Pub. No.: US 2004/0111622 A1
(43) Pub. Date: Jun. 10, 2004

(54) Method of and system for controlling access to personal information records

(76) Inventor: Roy Schoenberg, Boston, MA (US)

Correspondence Address: Mark G. Lappin, McDERMOTT, WILL & EMERY, 28 State Street, Boston, MA, 02109, US

(21) Appl. No.: 10/315,301

(22) Filed: Dec. 10, 2002

(51) Int. Cl. H04K 1/00; G06F 17/60

(52) U.S. Cl. 713/182; 705/2

(57) ABSTRACT

A system for distributing information for an individual over a communications network includes a host server system having a computer processor and associated memory, the host server system having a database of a plurality information categories for the individual. Each of the categories has an information set of the individual contained therein, and each of the categories has one or more security access codes assigned thereto. A request system includes a computer processor and associated memory, the request system for inputting one or more of the security access codes provided to the requestor, by the individual, to the host server system over the communications network. The system further includes an access determining device for transmitting, to the request system, the information in each of the categories in which the input security access codes match the assigned security access codes.

### FIELD OF THE INVENTION

This invention generally relates to a method of and system for controlling access to personal information records over a communications network, and more specifically to a method of and system for enabling the owner of the personal information to assign increasing levels of security to portions of an individual's medical records and linking each of the security levels to access security codes that must be supplied by the requester of the medical information in order to access the medical records.

### BACKGROUND OF THE INVENTION

When a patient is brought into a hospital for emergency care, it is very unlikely that the patient's information record will be present in the hospital. A patient's information record is very important, particularly in an emergency situation, as it typically contains information regarding the patient's blood type, allergies, medical history, etc. Typically, such records are at the location where the patient receives the majority of his or her medical care. In most cases, this is the location of the patient's primary care physician, thus making quick access to the record by the emergency care provider virtually impossible. Furthermore, even if the patient's information record is accessible, it is likely that much of the information in the record is scattered between several archives in various locations, is obsolete, redundant or indecipherable to the extent that it does not benefit the patient at the point of care.

Presently, the transfer of patients' information records between care providers is done in a number of different ways. Records can be transferred by phone, facsimile and overnight mail, however, these options are relatively slow, expensive and can be unreliable. The use of email for transferring medical records can be relatively simple and quick. However, email is typically too insecure for transferring the sensitive information contained in a patient's information record, and information can only be exchanged between parties that are aware of each other's email addresses. Smart cards, which contain memory devices in which a patient's data is stored, allow the patient to carry his or her records, thereby potentially enabling immediate access to the patient's record. However, the cards are easily lost or misplaced, thus endangering the securing of the record, and smart cards must be compatible with the smart card reader at a particular medical location, which may not always be the case. Furthermore, since the smart card must be physically present at the time the information is needed, remote consultation is impossible. For example, if an ambulance is bringing a patient to the hospital, the information contained in the smart card cannot be accessed by care providers at the hospital until the patient arrives. A further disadvantage of the above methods is that they generally do not permit only selective access to the patient's information, depending on the situation that has precipitated the need for the patient's medical data. For example, if the patient suffers a broken bone, while information regarding the patient's blood type and allergies might be necessary for the proper treatment of the injury, the patient's cardiological or serological data is not. None of the above methods can prevent unnecessary medical data from being divulged to the medical care provider, thus potentially risking the patient's privacy.

Furthermore, a system providing access to a patient's records should be accessible to authorized providers of medical care in a manner that encourages the providers to utilize the system, thereby enhancing the care received by the patient.

While the internet could be used to distribute medical records, there is presently no online system that is capable of securely distributing only the information from a patient's medical record that is necessary for the situation that has required access to the record. Placing patient information on the internet requires that patients accept the potential risk associated with the exposure of their information. Using a public network to make the information accessible at any point where care is not rendered, or to someone who impersonates a care provider. The scope of the information's availability is directly proportional to both the risk of exposure and to the potential benefit for the patient. Small, closed physical networks are inherently more secure, but serve only a single hospital. Patients seen by out-of-hospital specialists or in another hospital cannot benefit from informed care in those locations. Large, interoperable systems can provide enhanced functionality, but are more susceptible to security breaches. While exceptions do exist, it is generally accepted that, as the scope of access increases, the ability to guarantee privacy decreases.

Accordingly, it is an object of this invention to provide a secure method of and system for controlling access to personal information records, in which the medical care provider may be granted quick access to a patient's personal information record, but only to the information within the record that is necessary for the proper treatment of the patient at that time.

### SUMMARY OF THE INVENTION

The present invention is directed to a method of and system for controlling access to personal information records over a communications network. A patient's personal information record is divided into a hierarchy of categories, each category having a level of privacy associated therewith which is greater than the previous level. The lowest level category could include information such as blood type and allergies, while a high-level category could include the patient's HIV status. The patient constructs a list of access codes, wherein, the higher the level of the category, the more access codes are required to gain access to the category of the record. This enables the patient to control how much access to his or her medical records a particular medical care provider has, by selecting the access codes that are provided to the care provider. The system includes a server system which stores the list of access codes associated with each category of the patient's records and the identity of providers which have been granted access to the record by the patient. The provider, after initially inputting the required access codes on his or her computer system, need only select the particular patient from the software associated with the invention, to access the patient's information record. The access codes associated with the provider are stored on the server system with an identification indicator of the provider, such that the provider's system provides a pointer to the stored access codes, enabling the provider to obtain access to the authorized patient information records.

According to one embodiment of the present invention, a method of controlling access to personal information records includes the steps of:

A. categorizing personal information for an individual into a plurality of hierarchical sets of personal information;

B. assigning, by the individual, access priority data representative of an access priority level to each of the plurality of sets of personal information in the hierarchical sets, the access priority levels being based on differing criteria for release authorization for each of the plurality of sets of personal information established by the individual;

C. storing, at a datastore, each of the plurality of sets of personal information in the hierarchy and associated access priority data;

D. providing, by the individual to one or more requestors, access priority data corresponding to a desired level in the hierarchy;

E. receiving, from a requestor, by way of a communications network, a request for at least one of the plurality of sets of health information in the hierarchy, the request including access priority data correlated to an access priority level;

F. processing the access priority data to determine whether the access priority data corresponds to the access priority level for the requested health information; and

i. when the access priority data corresponds to the access priority level for the requested health information, transmitting the requested health information to the requestor by way of the communications network; and

ii. when the access data fails to correspond to the access priority level, denying access to the requestor to the health information.

The communications network may be the internet. The transmitted health information may be encrypted. The method may further include the step of designating certain of the access priority data as identification constraints which must be received in step D before access to the personal information is granted.

According to another aspect of the invention, a method of distributing information for an individual over a communications network includes the steps of:

A. generating a plurality of access security codes;

B. generating a plurality of hierarchical categories, ranging from a low security category to a high security category;

C. categorizing the individual's information into privacy levels ranging from a least private level to a most private level;

D. inputting the individual's categorized information into the plurality of hierarchical categories, the least private level being input into the low security category and the most private level being input into the high security category;

E. assigning, by the individual, to each of the categories, one or more of the access security codes, such that the information in each category will be released only if the assigned access security codes are received;

F. providing, by the individual, to one or more requesters access priority data corresponding to a desired level in the hierarchy;

G. receiving, from a requestor, one or more of the access security codes over the communications network;

H. determining whether the received access security codes match one or more of the assigned access security codes; and

I. transmitting, to the requestor over the communications network, the information in the categories in which the received security access codes match the assigned security access codes.

The method may further include the step of designating certain of the security access codes as identification constraints which must be received in step F before access to the information is granted. Prior to step F, identification information may be received from the requester, the identification information being for identifying the individual. The identification information may be selected from the group consisting of the individual's medical record numbers, demographic data, information from a smart card that identifies the patient, retinal scans, iris scans and fingerprints. The identification information may be any information about the individual which is available to the requester.

According to another aspect of the invention, a system for distributing information for an individual over a communications network includes a host server system having a computer processor and associated memory, the host server system having a database of a plurality information categories for the individual, each of the categories having an information set of the individual contained therein, each of the categories having one or more security access codes assigned thereto, a request system including a computer processor and associated memory, the request system for inputting one or more of the security access codes provided to the requestor by the individual, to the host server system over the communications network and an access determining device for transmitting, to the request system, the information in each of the categories in which the input security access codes match the assigned security access codes.

The system may further include a setup system, including a computer processor and associated memory, for inputting the information to the database. The security access codes may be defined by a user and are assigned to the categories by the user through the setup system. More security access codes may be required to access high security categories than low security categories. The setup system and the requester system may be the same system. The request system may be coupleable to the network by a wired connection. The request system may be selected from the group consisting of a personal computer, an interactive television system, a personal digital assistant and a cellular telephone. The request system may be coupleable to the network by a wireless connection.

### BRIEF DESCRIPTION OF THE DRAWINGS

The foregoing and other objects of this invention, the various features thereof, as well as the invention itself may be more fully understood from the following description when read together with the accompanying drawings in which:

FIG. 1 is a diagrammatic view of a system for distributing medical information in accordance with the present invention;

FIG. 2 is a flow diagram of a method of distributing medical information in accordance with the present invention;

FIG. 3 is a screen printout of a graphical user interface for obtaining access to a patient's record in accordance with the present invention;

FIGS. 4A and 4B are flow diagrams showing the steps involved in setting up or modifying a patient account in accordance with the present invention;

FIG. 5 is a flow diagram of the steps involved in a provider obtaining access to a patient's records in accordance with the present invention;

FIG. 6 is a block diagram illustrating the access code sequence concept in accordance with the present invention; and

FIG. 7 is a screen printout of a graphical user interface for viewing a patient's record in accordance with the present invention.

### DETAILED DESCRIPTION

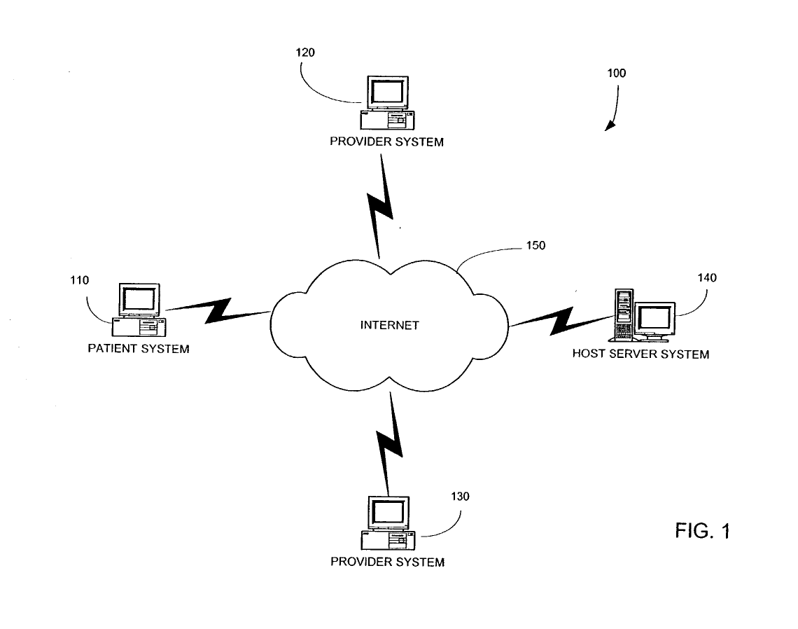

The present invention enables a medical care provider to have remote access to a patient's personal information record, while also enabling the patient to dictate exactly how much information the medical care provider can access. FIG. 1 shows a diagram of a system 100 for controlling access to a patient's personal information records in accordance with a preferred embodiment of the present invention. The system 100 includes a patient system 110, provider systems 120 and 130 and a host server system 140 all connected to a common communications network 150. Preferably, the patient system 110, provider systems 120 and 130 and host server system 140 can each be a personal computer such as an IBM PC or IBM PC compatible system or an APPLE® MacINTOSH® system or a more advanced computer system such as an Alpha-based computer system available from Compaq Computer Corporation or SPARC® Station computer system available from SUN Microsystems Corporation, although a main frame computer system can also be used. Preferably, the communications channel 150 is a TCP/IP-based network such as the Internet or an intranet, although almost any well known LAN, WAN or VPN technology can be used.

In one embodiment of the invention, the patient system 110 and provider systems 120 and 130 are IBM PC compatible systems operating a Microsoft Windows® operating system and host server system 140 is configured as a web server providing access to information such as web pages in HTML format via the HyperText Transport Protocol (http). The patient system 110 and provider systems 120 and 130 include software to allow viewing of web pages, commonly referred to as a web browser, thus being capable of accessing web pages located on host server system 140. Furthermore, patient system 110, provider systems 120 and 130 and host server system 140 include software for encrypting and decrypting data that is transmitted over the communications network 150. Alternatively, patient system 110 and provider systems 120 and 130 can be any wired or wireless device that can be connected to a communications network, such as an interactive television system, such as WEBTV, a personal digital assistant (PDA) or a cellular telephone. In this preferred embodiment, patient system 110 is located at the patient's home or primary care physician's office and provider systems 120 and 130 are located wherever access to a patient's medical record is required, such as in an emergency room, ambulance or another doctor's office. While two provider systems are shown as part of the system 100, it will be understood that any number of provider systems may be enabled to access the host server system 140 through the communications network 150.

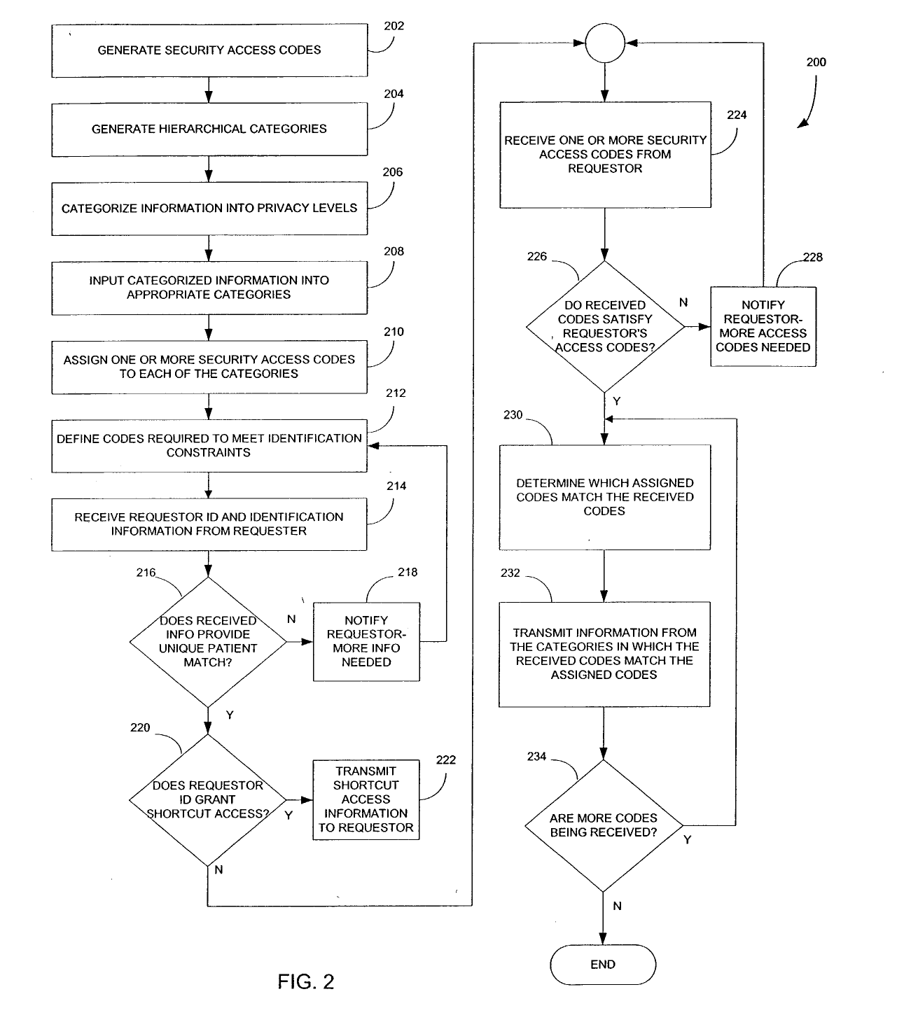

FIG. 2 shows a flow diagram 200 of the method of controlling access to personal information records according to the present invention. First, the user of the patient system 110, FIG. 1, who can be the patient or the patient's physician, generates security access codes, step 202, which will provide varying access to the patient's records. Such security access codes can include demographic data such as the patient's name, birth date, social security number, mother's maiden name, a driver's license number, address and phone number; non-demographic data such as a passport number and the patient's native language; physical attributes such as eye and hair color, scars, iris scans, finger prints or other identifying marks; and user-definable fields such as passwords. The user then generates hierarchical categories into which the patient's medical information will be stored, step 204. These categories range from a low security category, for information that the patient is less concerned about becoming known by an unauthorized third party, to a high security category, for information that the patient is more concerned about becoming known by an unauthorized third party. The patient and/or the patient's physician then determine the level of privacy that is desired for each piece of medical information in the patient's medical record, step 206. The least private level could include information such as the patient's blood type and allergies. The most private level could include HIV data. Intermediate levels of privacy may include serology data, psychiatric data, cardiology data and genetic data. Folders may be set up to store groups of similarly private information. After the levels of privacy for each piece of the patient's information are determined, the information is input to the appropriate category for the desired security, step 208. The patient then assigns one or a sequence of the security access codes to each of the categories, step 210. Preferably, security access codes that are easier to ascertain are assigned to low security categories, while security access codes that are more difficult to ascertain are assigned to high security categories. This allows the patient to more precisely control who has access to the categories, by enabling the patient to provide the security access codes for each of the categories only to medical personnel who have a “need-to-know” the particular information in each category.

As a further security measure, the patient can define which of the security access codes are necessary to be input by the requestor to identify the requestor as being authorized to access the patient's medical record, step 212. The security access code that will identify an authorized requester is preferably a code that will not be easily guessed by an unauthorized requestor. The provider identification information, patient identification information and access codes are stored in a database of the host server system 140

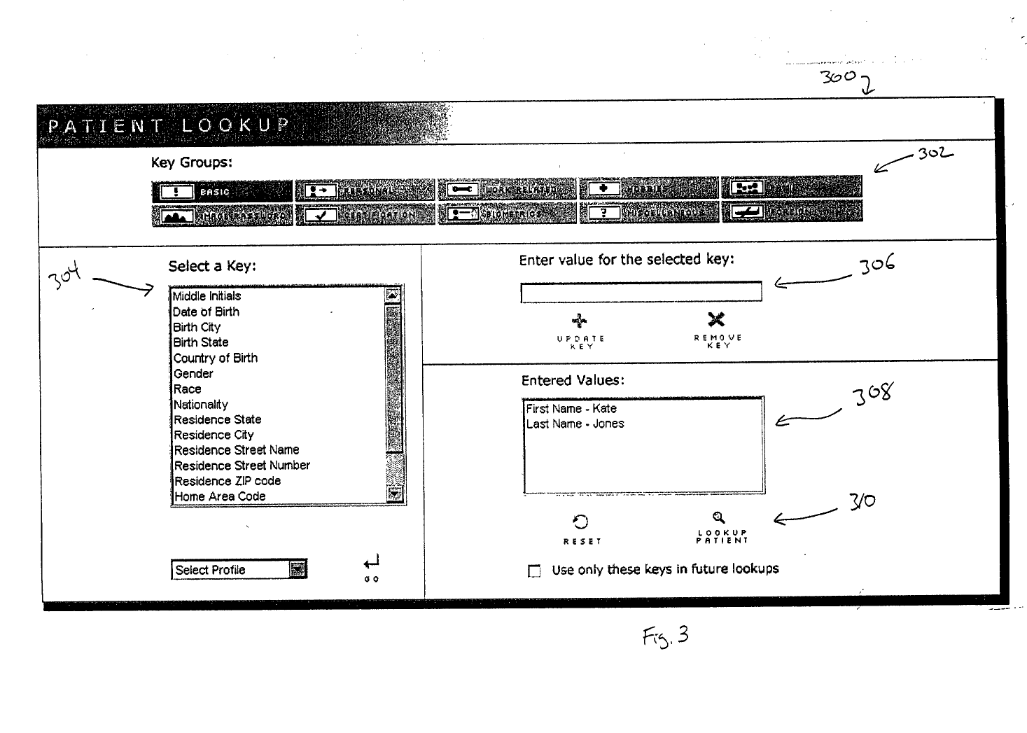

When a patient's record is needed, the requestor inputs to the host server system 140, FIG. 1, through provider system 120 and over network 150, any information that is known about the patient in order to identify the patient, as well as an identification index (ID) of the provider, step 214. FIG. 3 shows a preferred graphical user interface (GUI) 300 presented to the provider system 120 to enable the provider to enter known parameters of the patient to identify the patient and to determine which categories of information the provider will be able to access. GUI 300 includes identification group buttons 302, which, when selected, open window 304 which lists the parameters available for identification in the selected identification group. Each of these parameters is referred to as an access code or key. As shown in FIG. 3, when the “BASIC” identification group button is selected, window 304 lists basic identification parameters or keys such as the patient's name, date of birth, gender, race, etc. The provider then individually selects a key and provides the value for that key in text window 306. The correct set of entered keys is then displayed in entered values window 308. When the provider has entered the keys that pertain his or her access rights, as determined by the patient, the “Lookup Patient” button 310 is clicked and the host system 140 determines if the entered values for the selected keys match the access code sequence established by the patient for that provider, as described with respect to FIG. 2. If the entered values are correct, the provider is granted access to the particular information which the patient has deemed appropriate for that provider to have. If not, the provider is prompted to enter further values for selected keys.

While prior art systems require specific predetermined data to identify a patient, the present invention is capable of searching its database to identify the patient based on whatever information the requester can provide. Such information can include, but is not limited to, actual medical record numbers for a particular hospital, demographic data such as the patient's name, age and sex, information from a smart card that identifies the patient, retinal or iris scans and fingerprints. This flexible identification system enables the present invention to be used in conjunction with existing legacy systems. Since the database of host server system 140 may include records for a great number of patients, the host server system 140 determines whether, based on the identification information input by the requester, a unique patient match has been achieved, step 216. In this embodiment, the identification information input by the requestor could also be the security access codes set up by the patient. If the identification information input by the requestor does not define a unique patient in the database, the server system notifies the requestor that more identification information is needed to establish a unique patient match, step 218. If the identification information provided by the requestor provides a unique patient match, step 216, the host server system then determines whether the identification index input by the provider grants “shortcut” access for the provider, in which case a certain, patient-determined portion of the patient's record is immediately made available to the provider, step 222. Such a shortcut access grant could be useful for the patient's primary care physician to obtain basic information from the patient's record or for a specialist to obtain information pertinent to the condition being treated by the specialist, such as test results, etc.

If the provider's ID does not provide shortcut access, the host server system 140 prompts the requestor to enter security access codes for the patient. The server system then receives one or more of the security access codes input to the server system by the requestor, step 224. The host server system 140 determines whether the received security access codes satisfy the requester identification constraints, step 226. If they do not, the system notifies the requester that the identification constraints have not been satisfied, step 228. If the identification constraints have been satisfied, the host server system 140 determines which of the assigned access codes match the received access codes input by the requester, step 230, and transmits, to the provider system 120 over the network 150, the information from the categories in which the received security access codes match the assigned security access codes, step 232. The transmitted information may be encrypted in a manner which is known in the art. If more of the security access codes are received from the requestor, step 234, the system returns to step 230 to determine which of the assigned codes match the received codes. If no more codes are received in step 234, the process is terminated.

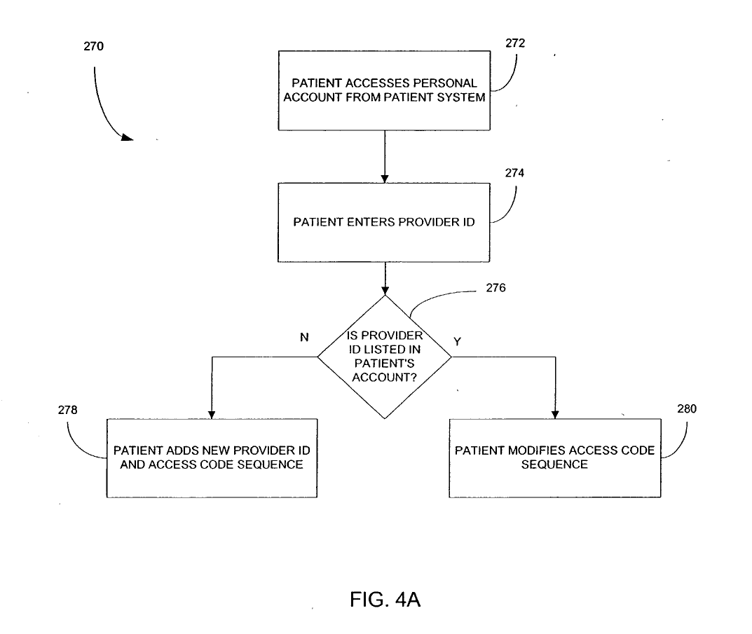

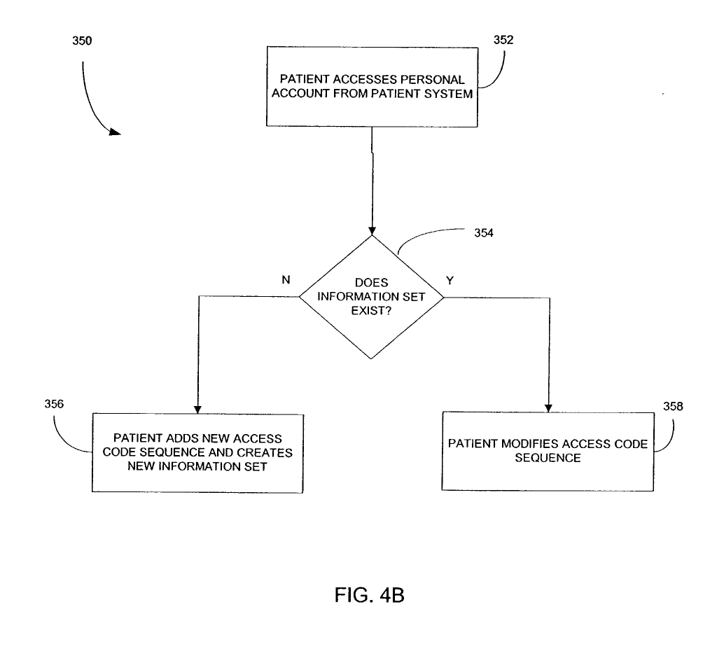

FIG. 4A shows a flow diagram 270 which depicts the steps taken by the patient to set up or modify an access code sequence for a particular provider. In step 272, the patient accesses his or her personal account from the patient system 110. Once the patient system 110 is connected to the host server system 140 over the network 150, the patient enters the ID of the provider for which access is to be set up or modified, step 274. If the provider ID is not listed in the patient's account, step 276, indicating that access has not yet been set up for that provider, the host system 140 prompts the patient to add the provider to his or her account, to establish an access code sequence specific to that provider, and to indicate which of the patient's information will be accessible by the provider, step 278. If the provider has already been set up in the patient's account, step 276, the patient is prompted by the host server system 140 to modify the access code sequence set up for that provider, step 280. In both steps 278 and 280, the patient is presented with a GUI similar to GUI 300, FIG. 3, for the purpose of selecting particular access codes or keys which will be required to be entered by the provider to access the patient's information, and which will also enable the patient to indicate which portions of the patients information records will be accessible by the provider when the correct access codes are entered.

Alternatively, FIG. 4B shows a flow diagram 350 which depicts the steps taken by the patient to set up or modify an access code sequence which is not linked to a particular provider. This enables the patient to allow a new provider to access certain of the patient's information without having to set up an access code sequence that is assigned to that provider. An example where this would be preferred is the case in which the patient is in an emergency room or walk-in clinic and is being treated by a provider who has not treated the patient in the past. In step 352, the patient accesses his or her personal account on the host server system 140 from the patient system 110. If the particular information set for which a new access code sequence is to be generated does not yet exist, step 354, the patient creates a new access code sequence and a new information set to which it is linked, step 356. If the information set already exists, the patient can then modify the access code which is linked to the information set, step 358.

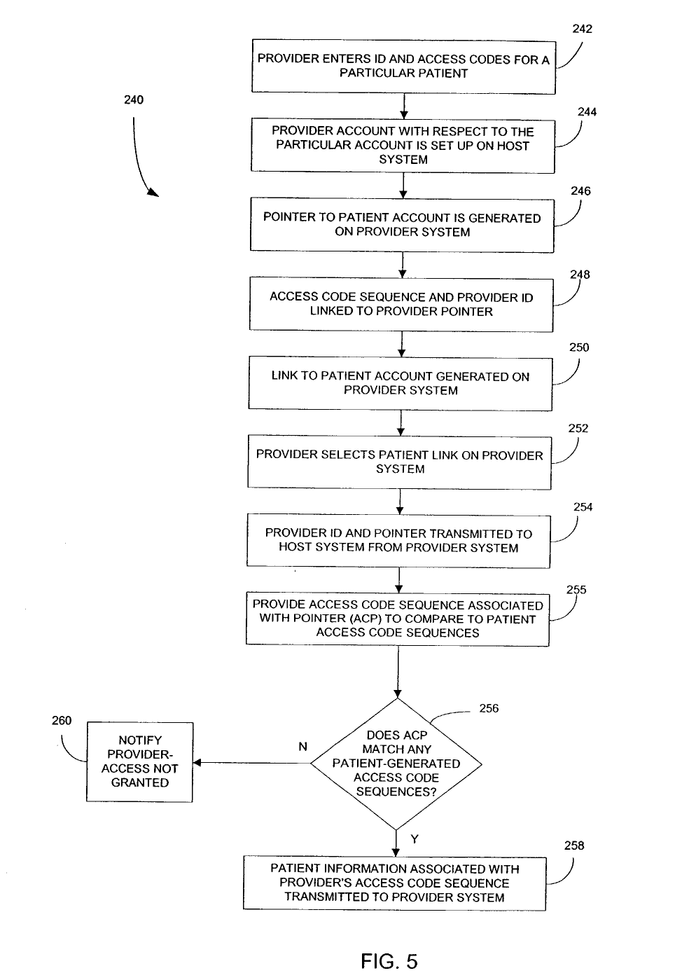

FIG. 5 shows a flow diagram 240 of another portion of the method of controlling access to information records according to the present invention. This diagram describes the process carried out by the provider in order to set up an account on the provider system 120, 130 for the purpose of enabling the provider to access the patient's records in an easily-accessible manner. This is extremely important, since a provider is more likely to adopt and use a network-based patient information record access system if obtaining a patient's information records is as easy or easier than the current method being used. In step 242, the provider enters his or her ID and the access codes to the provider system 120, 130, as described with respect to FIG. 2 and FIG. 3. The ID and input access codes are transmitted to the host server system 140 and a provider access account is then set up on the host server system, step 244. This account on the host server system includes the provider's ID and the input access codes. The access codes input by the provider are not stored on the provider system 120, 130, however, a pointer to the provider account on the host server system 140 is generated at the provider system, step 246. The provider ID and the input access codes stored on the host server system 140 are linked to the pointer on the provider system 120, 130, step 248, and a link which, when selected, transmits the ID and the pointer associated with a particular patient, is generated in a patient selection GUI on the provider system 120, 130, step 250. After the initial access code entry process, which is described with reference to FIG. 2, when the provider desires to access the patient's information record, the provider simply selects the patient link from the patient selection GUI on the provider system 120, 130, step 252. This action causes the provider ID and the pointer associated with the selected patient to be transmitted to the host server system 140, step 254, where the pointer “points” to the access code sequence entered by the provider upon the original set up (step 242). The access code sequence is compared to the patient-generated access code sequences in the patient's account on the host server system 140, step 255, to determine if the provider access code sequence matches any of the patient-generated access code sequences.

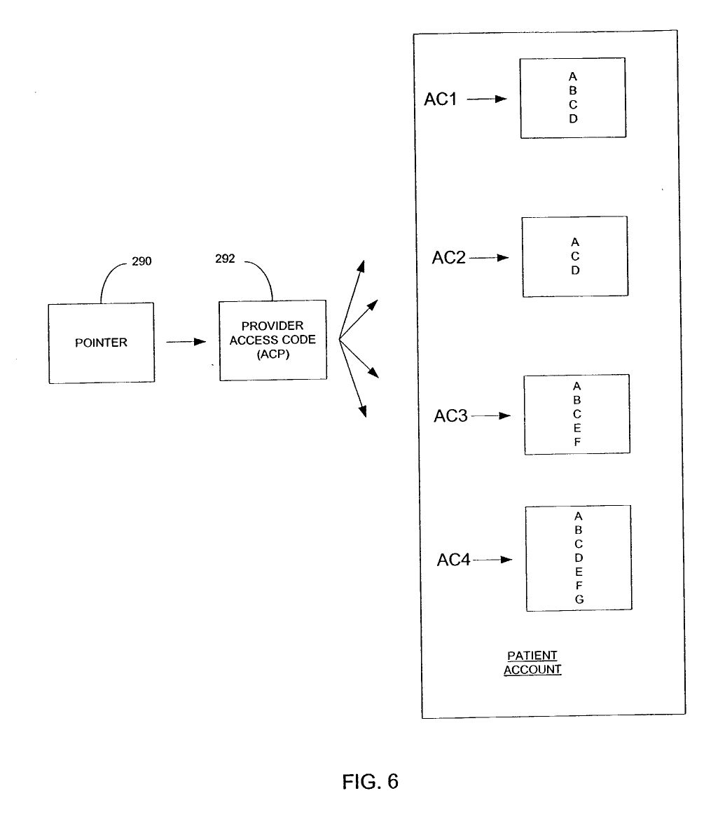

This comparison is shown graphically in FIG. 6. In this example, a number of patient-generated access code sequences AC1-AC4 are stored in the patient account on the host server system 140. Each access code sequence AC1-AC4 is the “key” that opens a predefined set of the patient's information, as determined by the patient, as described above with reference to FIG. 4. For example, access code sequence AC1 is associated with the set of patient information that includes items A, B, C and D of the patient's information record. Items A, B, C and D can be any of the patient's information, such as the patient's allergies, medications, psychiatric information, etc. As shown, each access code sequence AC1-AC4 is associated with a different set of the patient's information. When the pointer 290 is transmitted to the host server system in step 254, the provider's access code sequence (ACP) 292 is retrieved from the memory of the host server system 140 and is compared to the patient generated access code sequences AC1-AC4 to determine if a match exists between the input provider access code sequence and the patient generated access code sequences AC1-AC4. If a match does exist, step 256, FIG. 5, the information stored in the matching set is transmitted to the provider system 120, 130. If the provider access code sequence ACP does not match any of the patient generated access code sequences AC1-AC4, step 256, as would be the case if the patient modified access code sequences in his or her account, as described above with reference to FIGS. 4A and 4B, the provider is notified that access to the patient's record is denied, step 260, FIG. 5.

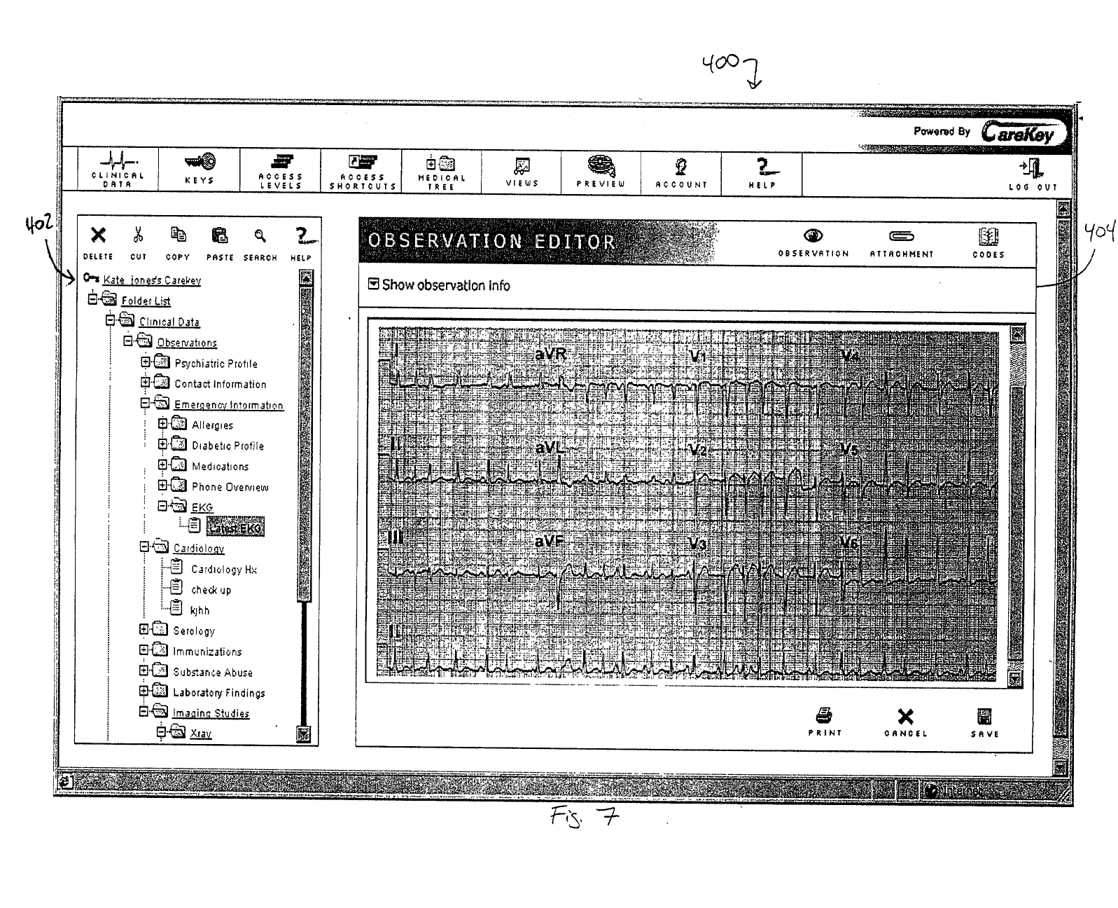

If, in step 256, the pointer points to a valid access code sequence and the patient information is transmitted to the provider system, step 258, the provider system is presented with the GUI 400 shown in FIG. 7. GUI 400 includes file tree window 402 which shows the patient's information record in the form of a file tree. In one embodiment, all of the files of a patient's record are shown in the file window 402, as shown in FIG. 7, and only the files which are accessible to the provider are active links that the provider can select to view the enclosed information. In another embodiment, only the files to which the provider has been granted access are shown in the file tree window 402. GUI 400 also includes an observation window 404 in which the information selected from the file tree window 402 is displayed. In the example shown in the figure, the patient's “Latest EKG” file has been selected by the provider and is displayed in observation window 404. Any file which is accessible to the provider, when selected from the file tree window 402, is displayed in observation window 404. The provider may also edit or update the information in the observation window 404.

Accordingly, the present invention includes a network-based system for providing personal information of the patient to providers regardless of where the provider is located, while enabling the patient to have complete control over who may access the information and what portions of the patient's information may be accessed by a particular provider. The patient's information is categorized based on privacy levels and sets of the information are linked to access code sequences. The access codes include demographical information of the patient, physical information of the patient and arbitrary information, such as passwords. In order for the patient to grant access to a particular information set, he or she need only provide the provider with the access code sequence that will enable the provider to access that information set. The patient may revoke access to the information set at any time by modifying the access code sequence that accesses the information set. Since the provider only knows the previous access code, he or she will not be able to access the information set.

The invention enables the patient to allow his or her primary care physician to access a certain portion (or all) of the information record, while allowing a specialist to access a different portion of the record, and allowing an “unknown” provider, such as an emergency room or walk-in facility provider to access a limited portion of the information record. At all times, access to the information is completely controlled by the patient, but the information is accessible to approved providers in a manner that is extremely efficient and user-friendly for the provider.

The system and method may be embodied in other specific forms without departing from the spirit or essential characteristics thereof. The present embodiments are therefore to be considered in respects as illustrative and not restrictive, the scope of the system and method being indicated by the appended claims rather than by the foregoing description, and all changes which come within the meaning and range of the equivalency of the claims are therefore intended to be embraced therein.

1. A method of controlling access to personal information records, comprising the steps of:
A. categorizing personal information for an individual into a plurality of hierarchical sets of personal information;
B. assigning, by said individual, access priority data representative of an access priority level to each of said plurality of sets of personal information in said hierarchical sets, said access priority levels being based on differing criteria for release authorization for each of said plurality of sets of personal information established by said individual;
C. storing, at a datastore, each of said plurality of sets of personal information in said hierarchy and associated access priority data;
D. providing, by said individual to one or more requesters, access priority data corresponding to a desired level in said hierarchy;
E. receiving, from a requester, by way of a communications network, a request for at least one of said plurality of sets of health information in said hierarchy, said request including access priority data correlated to an access priority level;
F. processing said access priority data to determine whether said access priority data corresponds to said access priority level for said requested health information; and
i. when said access priority data corresponds to said access priority level for said requested health information, transmitting said requested health information to said requester by way of said communications network; and
ii. when said access data fails to correspond to said access priority level, denying access to said requestor to said health information.

2. The method according to claim 1, wherein said communications network is the internet.

3. The method according to claim 1, wherein said transmitted health information is encrypted.

4. The method according to claim 2 further comprising the step of designating certain of said access priority data as identification constraints which must be received in step D before access to said personal information is granted.

5. A method of distributing information for an individual over a communications network comprising the steps of:
A. generating a plurality of access security codes;
B. generating a plurality of hierarchical categories, ranging from a low security category to a high security category;
C. categorizing the individual's information into privacy levels ranging from a least private level to a most private level;
D. inputting the individual's categorized information into said plurality of hierarchical categories, said least private level being input into said low security category and said most private level being input into said high security category;
E. assigning, by said individual, to each of said categories, one or more of said access security codes, such that said information in each category will be released only if the assigned access security codes are received;
F. providing, by said individual, to one or more requestors access priority data corresponding to a desired level in said hierarchy;
G. receiving, from a requestor, one or more of said access security codes over said communications network;
H. determining whether said received access security codes match one or more of said assigned access security codes; and
I. transmitting, to said requestor over said communications network, said information in said categories in which said received security access codes match said assigned security access codes.

6. The method of distributing information for an individual over a network according to claim 5, wherein said communications network is the internet.

7. The method of distributing information for an individual over a network according to claim 6, wherein said released information is encrypted.

8. The method of distributing information for an individual over a network according to claim 6 further comprising the step of designating certain of said security access codes as identification constraints which must be received in step F before access to said information is granted.

9. The method of distributing information for an individual over a network according to claim 6 wherein, prior to step F, identification information is received from the requestor, said identification information being for identifying the individual.

10. The method of distributing information for an individual over a network according to claim 9 wherein said identification information is selected from the group consisting of the individual's medical record numbers, demographic data, information from a smart card that identifies the patient, retinal scans, iris scans and fingerprints.

11. The method of distributing information for an individual over a network according to claim 9 wherein said identification information is any information about the individual which is available to said requester.

12. A system for distributing information for an individual over a communications network comprising:
a host server system including a computer processor and associated memory, said host server system having a database of a plurality information categories for the individual, each of said categories having an information set of said individual contained therein, each of said categories having one or more security access codes assigned thereto;
a request system including a computer processor and associated memory, said request system for inputting one or more of said security access codes provided to said requester by said individual, to said host server system over said communications network; and
an access determining device for transmitting, to said request system, the information in each of said categories in which said input security access codes match said assigned security access codes.

13. The system of claim 12 wherein said communications network is the internet.

14. The system of claim 13, further including a setup system, including a computer processor and associated memory, for inputting said information to said database.

15. The system of claim 14 wherein said security access codes are defined by a user and are assigned to said categories by said user through said setup system.

16. The system of claim 13 wherein more of said security access codes are required to access high security categories than low security categories.

17. The system of claim 13 wherein said setup system and said requestor system are the same system.

18. The system of claim 13 wherein said request system is coupleable to said network by a wired connection.

19. The system of claim 18 wherein said request system is selected from the group consisting of a personal computer, an interactive television system, a personal digital assistant and a cellular telephone.

20. The system of claim 13 wherein said request system is coupleable to said network by a wireless connection.

21. The system of claim 20 wherein said request system is selected from the group consisting of a personal computer, an interactive television system, a personal digital assistant and a cellular telephone.

22. The system of claim 14 wherein said setup system is coupleable to said network by a wired connection.

23. The system of claim 22 wherein said setup system is selected from the group consisting of a personal computer, an interactive television system, a personal digital assistant and a cellular telephone.

24. The system of claim 14 wherein said setup system is coupleable to said network by a wireless connection.

25. The system of claim 24 wherein said setup system is selected from the group consisting of a personal computer, an interactive television system, a personal digital assistant and a cellular telephone.
